(19) United States
(12) Patent Application Publication
(10) Pub. No.: US 2005/0169591 A1
(43) Pub. Date: Aug. 4, 2005

(54) Planar optical waveguides with photonic crystal structure

(75) Inventors: Jes Broeng, Kgs. Lyngby (DK); Anders Bjarklev, Roskilde (DK)

Correspondence Address: CANTOR COLBURN, LLP, 55 GRIFFIN ROAD SOUTH, BLOOMFIELD, CT, 06002, US

(73) Assignee: Technical University of Denmark, DTU, Kgs. Lyngby (DK)

(21) Appl. No.: 10/506,338

(22) PCT Filed: Mar. 14, 2003
(86) PCT No.: PCT/DK03/00171

Related U.S. Application Data
(60) Provisional application No. 60/364,869, filed on Mar. 15, 2002.

(51) Int. Cl. G02B 6/10

(52) U.S. Cl. 385/129

(57) ABSTRACT

Planar optical waveguide comprising a core region and a cladding region comprising a photonic crystal material, said photonic crystal material having a lattice of column elements, wherein at least a number of said column elements are elongated substantially in an axial direction for said core region. The invention also relates to optical devices comprising planar optical waveguides and methods of making waveguides and optical devices.

### CROSS-REFERENCE TO RELATED APPLICATION

This application, filed under 35 U.S.C. §363, claims the benefit pursuant to §119(e) of U.S. provisional patent application No. 60/364,869 filed on Mar. 15, 2002, the contents of which are herein incorporated by reference in their entirety.

### FIELD OF THE INVENTION

The present invention relates to planar optical waveguides and devices that operate by photonic bandgap effects. The invention provides a new range of photonic bandgap (PBG) guiding optical waveguides and devices of a new design, which may be implemented in a number of ways and which may be implemented using structures that do need to contain any voids. The optical waveguides and devices covered by the present invention may be employed for a number of applications, including amplifiers and lasers, coupling devices, and sensors. The invention further provides a number of methods for fabricating such waveguides and devices.

### BACKGROUND OF THE INVENTION

Within the past few years, a significant research interest has been pointed towards planar optical waveguides and devices that incorporate microstructured features—see for example J. D. Joannopoulos, J. N. Winn and R. D. Meade, “Photonic Crystals: Molding the Flow of Light”, Princeton University Press. Princeton, N.J., 1995. Such microstructures are generally characterized as 1, 2, or 3 dimensional photonic crystals—depending on the degree of periodicity—and may exhibit photonic bandgap (PBG) effects in 1, 2, or 3 dimensions, respectively. The present invention relates to planar optical waveguides and devices having microstructured features having 2-dimensional (2D) periodicity.

In order to realise photonic bandgap effects in more than one dimension, it is generally believed that materials having relative large index differences must be employed. As known to those skilled in the art, a minimum refractive index contrast of around 1.0 to 2.6 is required for in-plane two-dimensional (2D) PBG effects to take place. Hence, materials such as air (with a refractive index of 1.0) and silica (with a refractive index of 1.45) do not provide sufficient refractive index contrast to provide in-plane 2D PBG effects. Indeed, neither does material systems comprising solely silica and silica co-dopants with refractive index differences in the range from around 1.40 to 1.50 provide sufficient refractive index change for 2D in-plane photonic bandgap effects.

### BRIEF SUMMARY OF THE INVENTION

By the present invention it has been realized that low-index contrast structures may, in fact, exhibit useful PBGs in exactly the opposite case of that taught in the prior art—namely, in the case of low-contrast structures having high-index features disposed in a background material with a slightly lower refractive index and wave propagation in the direction parallel to the microstructured features. In particular, by the present invention it has been realized that high-index features with a refractive index of around 1.46 disposed in a background material with a refractive index of around 1.45 may provide broadband PBGs that can be utilized for planar optical waveguides and devices. Hence, new planar PBG-based optical waveguides and devices realized purely using silica and silica incorporating various dopants becomes feasible using the present invention, as shall be demonstrated throughout the detailed description of the present invention.

For compatibility with conventional, silica-based planar optical technology, it is a disadvantage that prior art PBG waveguides and devices incorporates high-index contrasts materials, such as for example voids and silica, or voids and semiconductors.

The invention provides an improved planar waveguide utilizing the photonic bandgap technique.

The invention provides functional PBG-based waveguides and devices that do not comprise any voids or low-index features at all. In particular, it is an object of the present invention to provide PBG-based waveguides and functional components that may be realised solely from silica-based materials. Such as to provide such waveguides and devices that may be fabricated using index contrasts that are feasible within silica technology (for example using Ge, Al, F and/or other dopants that may be incorporated into silica).

It is a further disadvantage of prior art PBG-based optical waveguides and devices that a large refractive index difference between the core/cladding features and the background material results in a high sensitivity towards minor structural inaccuracies for certain waveguide or device properties.

The invention further provides PBG waveguides that have small index contrast between the constituting materials in order to eliminate degrading effects such as polarization sensitivity.

Further, it is an objective to provide such a waveguide which may be manufactured in an improved manner, whereby the necessary resources involved may be reduced.

The invention also provides such a waveguide which may be manufactured in a improved manner using readily available processing techniques.

to the invention still further provides such a waveguide which may in an efficient manner be integrated with other optical devices.

The invention also provides a method for manufacturing a planar optical waveguide and/or an optical device in an improved and cost-efficient manner.

These and other advantages are achieved by the invention as explained in the following.

The invention relates to a planar optical waveguide comprising
a core region and
a cladding region comprising a photonic crystal material,
   said photonic crystal material having a lattice of column elements, wherein at least a number of said column elements are elongated substantially in an axial direction for said core region.

Hereby a new range of planar waveguides utilizing the photonic bandgap technique has been provided. This new range of designs facilitates a number of advantages, e.g. implementation using new methods and/or materials within the field. Thus, a planar waveguide according to the invention may also be manufactured using readily available processing techniques. Further, by the invention, integration with other optical devices may be performed in a relatively simple manner. It will further be understood that a planar waveguide according to this invention may be manufactured without using voids, e.g. air voids as is the case with the prior art techniques. Thus, drilling, etching, etc. of holes etc. need not be performed in order to manufacture a planar waveguide. according to the invention.

In a preferred embodiment, said core region may at least partly be in the form of a defect in said lattice of the photonic crystal material. Hereby a planar optical waveguide using the PBG technique may be provided in an advantageous manner according to this embodiment.

Advantageously, said core region may comprise a material having a low effective index of refraction and said cladding region may involve a higher effective index of refraction. It will thus be understood that this embodiment may be implemented using only two different materials or rather two forms of material having different refractive indices.

In a preferred embodiment, said cladding region may comprise a background material having a first refractive index (n₁), said column elements may comprise a material having a second refractive index (n₂), and said second refractive index (n₂) may be higher than said first refractive index (n₁).

In another preferred embodiment, said cladding region may comprise a background material having a first refractive index (n₁), said column elements may comprise a material having a second refractive index (n₂), and said second refractive index (n₂) may be lower than said first refractive index (n₁).

In a particular preferred embodiment, an effective refractive ratio for said cladding region, e.g. a ratio between said second refractive index (n₂) for said column element(s) and said first refractive index (n₁) for said background material, may be defined and said ratio may be less than 2.0. Hereby an embodiment has been implemented, whereby useful PBG effect is provided using a fairly low-index contrast ratio. Thus, planar PBG-based optical waveguides may be realized using a number of materials that has not been feasible according to prior art techniques.

Preferably, said effective refractive ratio for said cladding region may be less than 1.5, in a more preferred form less than 1.3, in a still more preferred form less than 1.2 and in a still further preferred form less than 1.1. Hereby a further advantageous embodiment has been implemented, whereby useful PBG effect is provided using an even lower index contrast ratio.

In a still further preferred form, said effective refractive ratio for said cladding region may be less than 1.05, in a more preferred form less than 1.04, in a still more preferred form less than 1.03, and in a still further preferred form less than 1.02. According to this embodiment, planar optical waveguides having a—compared with conventional techniques—surprisingly low index contrast ratio have been provided.

In an advantageous embodiment, said core region may comprise a material identical to or similar to a material forming background material of said cladding region. Thus, manufacture may be simplified, e.g. since fewer materials are needed. The core region may preferably be identical to the background material or it may comprise background material in modified form, e.g. in regard to refractive index etc. It will be understood that other forms, combinations and medications are possible.

In a further preferred embodiment, said columns elements may comprise a material containing impurity elements, e.g. Germanium doped into silica glass. Hereby, column elements may be manufactured in an advantageous manner, e.g. by doping, since according to the invention PBG-effect can be implemented using low-index-contrast ratio. Thus, the change of refractive index presented by doping using impurity elements will be satisfactory according to the invention. It is understood that a wide variety of materials, impurities and combinations hereof may be utilized in accordance with the invention.

In a still further preferred embodiment, said waveguide may comprise glass materials, semiconductor materials, and/or polymer materials. Hereby, a number of materials, the use of which has not been feasible according to prior art techniques, may be utilized for manufacturing planar PBG-waveguides according to the invention.

Advantageously, said cladding region may comprise a background material comprising or consisting of SiO₂ and said background material may have a first refractive index (n₁), wherein 1.4≦n₁≦1.5, in a more preferred form 1.43≦n₁≦1.47, and in a still more preferred form 1.44≦n₁≦1.45. Hereby, use of a material that has not been employed or studied for conventional planar optical waveguides is presented according to the invention.

In a further embodiment, said cladding region may comprise a background material comprising or consisting of Si and said background material may have a first refractive index (n₁), wherein 2.5≦n₁≦3.0, in a further preferred form 2.6≦n₁≦2.9, and in a still further preferred form 2.7≦n₁≦2.8. Hereby, use of a further material that has not been employed or studied for conventional planar optical waveguides is presented according to the invention.

In a still further embodiment, said cladding region may comprise a background material comprising or consisting of a Group III-V material and said background material may have a first refractive index (n₁), wherein 3.0≦n₁≦4.5, in a further preferred form 3.3≦n₁≦4.3, and in a still further preferred form 3.7≦n₁≦4.0. Hereby, use of further materials that has not been employed or studied for conventional planar optical waveguides is presented according to the invention.

Advantageously, said column elements may comprise a material comprising or consisting of SiO₂ and said material may have a second refractive index (n₂), wherein 1.0≦n₂≦1.5, in a preferred form 1.4≦n₂≦1.5, in another preferred form 1.43≦n₂≦1.47, and in a still further preferred form 1.44≦n₂≦1.45. Hereby, use of a material that has not been employed or studied for conventional planar optical waveguides is presented according to the invention.

In a further embodiment, said column elements may comprise a material comprising or consisting of Si and said material may have a second refractive index (n₂), wherein 1.0≦n₂≦3.0, in a preferred form 2.5≦n₂≦3.0, in another preferred form 2.6≦n₂≦2.9, and in a still further preferred form 2.7≦n₂≦2.9. Hereby, use of a further material that has not been employed or studied for conventional planar optical waveguides is presented according to the invention.

In a still further embodiment, said column elements may comprise a material comprising or consisting of a Group III-V material and said material may have a second refractive index (n₂), wherein 10.0≦n₂≦4.5, in a preferred form 3.0≦n₂≦4.5, in another preferred form 3.3≦n₂≦4.3, and in a still further preferred form 3.7≦n₂≦4.0. Hereby, use of further materials that has not been employed or studied for conventional planar optical waveguides is presented according to the invention.

Advantageously, said lattice of column elements may comprise a lattice constant (Λ), a normalized wavelength λ/Λ may be defined by means of said lattice constant (Λ) and a wavelength (λ) for optical waves propagated by the waveguide and said cladding region may comprise a background material comprising or consisting of SiO₂, wherein Λ/λ<1.0, in a further preferred form 0.1<Λ/λ<0.8, and in a still further preferred form 0.2Λ/λ<0.5. Hereby, an advantageous embodiment has been provided.

In a further embodiment, said lattice of column elements may comprise a lattice constant (Λ), a normalized wavelength λ/Λ may be defined by means of said lattice constant (Λ) and a wavelength (λ) for optical waves propagated by the waveguide and said cladding region may comprise a background material comprising or consisting of Si, wherein Λ/λ<2.0 and in a further preferred form Λ/λ<1.5. Hereby, a further advantageous embodiment has been provided.

In a still further embodiment, said lattice of column elements may comprise a lattice constant (Λ), a normalized wavelength λ/Λ may be defined by means of said lattice constant (Λ) and a wavelength (λ) for optical waves propagated by the waveguide and said cladding region may comprise a background material comprising or consisting of a Group III-V material, wherein Λ/λ<3.0. Hereby, a still further advantageous embodiment has been provided.

Working on a higher index contrast, it will—with reference to FIG. 9.c—be possible to push the mode-splitting point further downwards (with regard to mode index) and at the same time out to larger values of the normalized wavelength Λ/λ.

Preferably, said cladding region may comprise a background material having a first refractive index (n₁), and an effective guided mode index may be lower than said first refractive index (n₁).

Preferably, said column elements may comprise a material having a second refractive index (n₂), and an effective guided mode index may be lower than said second refractive index (n₂).

The invention also relates to an optical device comprising a planar optical device. Hereby optical devices involving new combinations of advantageous features may be provided e.g. hybrid optical devices comprising prior art optical devices and planar optical PBG waveguides according to the invention.

Further, the invention relates to an optical device comprising an optical amplifier and further comprising a planar optical device. Hereby an advantageous design of an optical device may be provided, said design further facilitating a number of advantageous features, e.g. including improved manufacturing methods, cost efficiency, improved lay-out etc.

The invention also relates to an optical device comprising a laser and further comprising a planar optical device. Hereby an advantageous design of an optical device comprising a laser construction may be provided allowing e.g. improved manufacturing methods, cost efficiency, improved lay-out etc.

Still further, the invention relates to an optical device comprising an optical filter and further comprising a planar optical device. Hereby an advantageous design of an optical device comprising an optical filter construction may be provided.

The invention also relates to an optical device comprising an add-drop multiplexer and further comprising a planar optical device. Hereby an advantageous design of an optical device comprising an add-drop multiplexer construction may be provided.

Further, the invention relates to an optical device comprising an optical splitter and further comprising a planar optical device. Hereby an advantageous design of an optical device comprising an optical splitter construction may be provided.

Still further, the invention relates to an optical device comprising a wavelength converter and further comprising a planar optical device. Hereby an advantageous design of an optical device comprising a wavelength converter construction may be provided.

The invention also relates to an optical device, said optical device comprising means for performing an optical switching, a controllable coupling or a transferal of optical waves, said optical device further comprising a planar optical device. Hereby an optical device for performing optical switching may be provided in an advantageous manner utilizing the planar optical waveguide design according to the invention. A number of advantageous features may be provided in this manner, e.g. allowing for new manufacturing methods, cost-efficient manufacturing, new applications etc.

Advantageously, said means for performing an optical switching, a controllable coupling or a transferal of optical waves may comprise a movable coupling element. Hereby, control of optical switching may be established in an efficient manner, directly or indirectly, e.g. through means to move the coupling element, e.g. by heating, change of volume, change of pressure, change of an electromagnetic field etc.

Advantageously, the device may comprise means for actuating said movable coupling element. Hereby actuation may be provided in a relatively simple and efficient manner, e.g. using a rod, a string, or other means such as pneumatic, hydraulic etc. means.

In a preferred embodiment, said means for actuating said movable coupling element may involve the use of mechanical means, means sensitive to heating and/or cooling, means sensitive to pressure and/or means sensitive to electromagnetic fields, voltage, current, strain etc.

In a further preferable embodiment, said device may comprise micro-flow means associated with said optical switching, controllable coupling or transferal of optical waves. Such micro-flow means may for example comprise one or more elements of liquids, e.g. liquids for guiding light and/or for moving separate guiding or switching means. Further, such liquids, if more than one is used, may not mix, whereby separation of the liquids are assured in an efficient manner.

In a particular advantageous embodiment, said micro-flow means may involve utilization of a fluid, in particular two or more fluid elements having different refractive indices. Advantageously, such micro-flow means may for example comprise different elements of liquids that do not mix and which have different refractive indices. Hereby, modified coupling properties will be achieved by moving said liquids in the optical device.

Advantageously, said two or more fluid elements comprised in said micro-flow system may be separated by mechanical means or preferably said two or more fluid elements may be non-mixable fluid elements or essentially non-mixable fluid elements.

The invention also relates to method of making a planar optical waveguide, in particular a planar optical waveguide, said method comprising steps involving multi-layer depositing and/or processing. Hereby, an optical waveguide or device according to the invention may be manufactured in an efficient manner, said manner facilitating use of a vide variety of suitable materials and/or methods.

Advantageously, said steps may comprise depositing, etching and/or lithographic processes. Such methods are generally know and readily available and allow said manufacturing to be performed in an efficient and cost-effective manner.

The invention also relates to method of making a planar optical waveguide, in particular a planar optical waveguide, said method comprising steps involving laser induced refractive index changes. Hereby an optical waveguide or device according to the invention may be manufactured in an efficient manner, e.g. by subjecting a slab to a laser beam, whereby the material in question will change its refractive index. An added advantage of this method will be that the lay-out of the elements, e.g. elongated elements, may readily be controlled by moving the laser apparatus and the slab relatively and/or by controlling the position of the laser beam.

The invention also relates to method of making a planar optical waveguide, in particular a planar optical waveguide, said method comprising steps involving self-writing waveguides. Hereby a particularly advantageous method is provided since the laser beam will create a channel having a changed refractive index, said channel defining an elongated element in e.g. a slab. Hereby, a elongated element positioned in the interior of a slab may be manufactured in a relatively simple and accurate manner.

The invention further relates to method of making a planar optical waveguide, in particular a planar optical waveguide, said method comprising steps involving ion implantation. Hereby a further advantageous method has been provided for creating elements and in particular elongated elements having a refractive index differing from the index of the surroundings, i.e. a method particularly suitable for manufacturing optical waveguides and devices according to the invention.

### BRIEF DESCRIPTION OF THE FIGURES

The invention will be explained in further detail below with reference to the figures of which

FIG. 1 shows in a perspective view a planar photonic bandgap device according to a prior art technique,

FIG. 2 shows part of such a prior art device seen from above, illustrating the lattice structure,

FIG. 3 shows a structure similar to the one shown in FIG. 2 in a perspective view,

FIG. 4 illustrates typically 2D photonic bandgaps for a prior art 2D photonic crystal for use in planar optical circuitry,

FIG. 5 shows a planar photonic bandgap waveguide according to a first embodiment of the invention in a perspective view,

FIG. 6 shows a waveguide corresponding to the waveguide shown in FIG. 5, but in a modified embodiment,

FIG. 7 shows an embodiment of a planar photonic bandgap waveguide structure according to the invention,

FIG. 8 shows an alternative embodiment of the embodiment shown in FIG. 7,

FIGS. 9a and b show part of a cross-section of a cladding structure for a planar optical waveguide or planar optical device according to the present invention,

FIG. 9c shows a calculation of allowed modes in a structure as schematically shown in FIG. 9b,

FIG. 10 shows an optical device according to an embodiment of the invention, which has been combined with a prior art planar photonic bandgap device,

FIG. 11 shows a further embodiment of an optical device according to the invention, whereby a coupling or switching of light between waveguides may be achieved,

FIG. 12 shows a still further embodiment of an optical device according to the invention, whereby a controllable coupling between optical waveguides may be achieved and which may be utilized in a vide variety of applications,

FIG. 13 illustrates a method of manufacturing a planar optical waveguide according to the invention by using a multi-layer method,

FIG. 14 illustrates in detail a method for manufacturing a planar optical waveguide as shown in FIG. 13,

FIG. 15 illustrates an arrangement for manufacturing an optical device according to the invention by using laser induced refractive index changes, and

FIG. 16 illustrates a further method for manufacturing using self-written waveguides.

### DETAILED DESCRIPTION

In the present application it will be distinguished between “refractive index” and “effective refractive index”. The refractive index is the conventional refractive index of a homogeneous material. In this application mainly optical wavelengths in the visible to near-infrared regime (wavelengths from approximately 400 nm to 2 μm) are considered. In this wavelength range most relevant materials for waveguide production (e.g. silica) may be considered mainly wavelength independent, or at least not strongly wavelength dependent. However, for non-homogeneous materials, such as micro-structures, the effective refractive index is very dependent on the morphology of the material. Furthermore the effective refractive index of a micro-structure is strongly wavelength dependent—much stronger than the refractive index of any of the materials composing the micro-structure. The procedure of determining the effective refractive index of a given micro-structure at a given wavelength is well-known to those skilled in the art (see e.g. Jouannopoulos et al, “Photonic Crystals”, Princeton University Press, 1995 or Broeng et al, Optical Fiber Technology, Vol. 5, pp. 305-330, 1999).

Usually a numerical method capable of solving Maxwell's equation on full vectorial form is required for accurate determination of the effective refractive indices of micro-structures. The present invention makes use of employing such a method that has been well-documented in the literature (see previous Joannopoulos-reference). In the long-wavelength regime, the effective refractive index is roughly identical to the weighted average of the refractive indices of the constituents of the material. For micro-structures, a directly measurable quantity is the so-called filling fraction that is the volume of disposed features in a micro-structure relative to the total volume of a micro-structure. Of course, for waveguides that are invariant in the axial waveguide direction, the filling fraction may be determined from direct inspection of the waveguide cross-section.

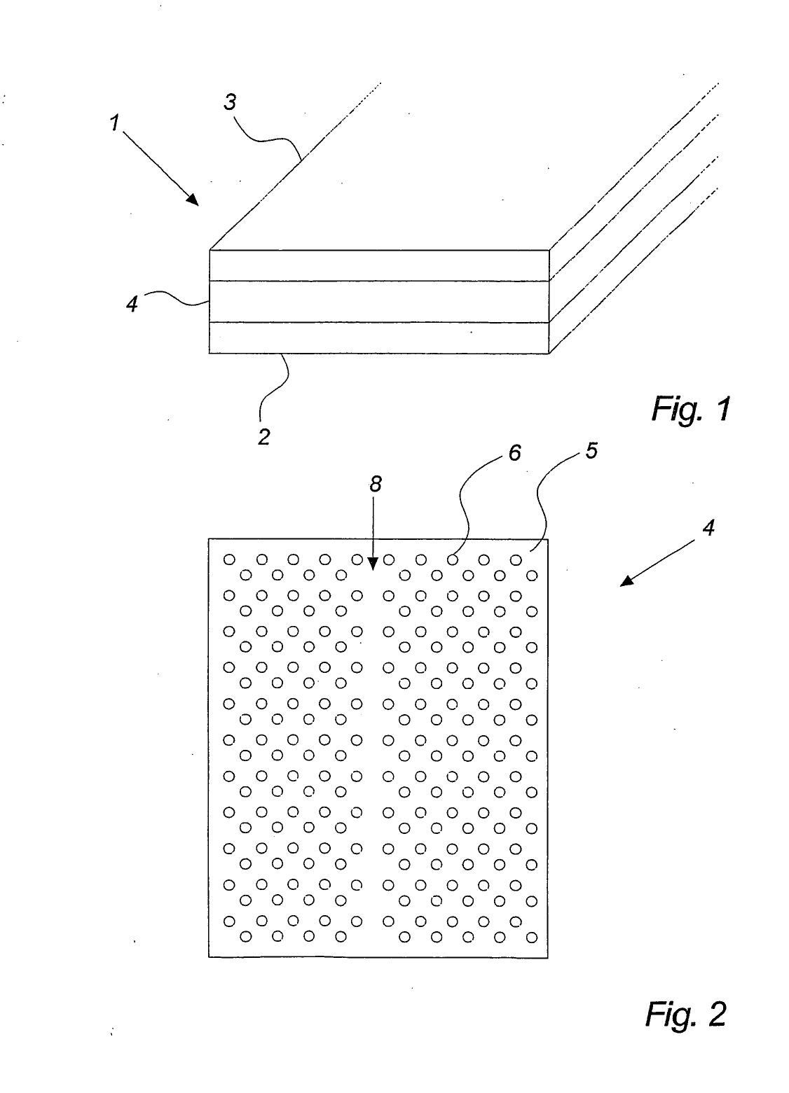

FIG. 1 shows in a perspective view a planar photonic bandgap device generally designated 1 according to a prior art technique. This planar photonic bandgap (PBG) device comprises a slab 4 placed between an upper 3 and a lower layer 2. These layers 2 and 3 serves to confine optical waves to the slab 4 by total internal reflection (TIR). The slab 4 according to this prior art technique comprises a 2 dimensional (2D) lattice, e.g. a lattice comprising a number of elements 6 extending transversely to the plane of the slab 4 as indicated in FIG. 2 which shows the slab 4 from above. The elements 6 will exhibit a relatively high index of refraction in relation to the index of refraction of the rest of the slab material, e.g. the background material 5, thereby creating a photonic bandgap (PBG) material, i.e. a material wherein light with a frequency within a certain frequency interval or certain frequency intervals is not allowed to propagate.

The lattice structure may according to the prior art technique be configured in a number of manners, e.g. in a triangular lattice as illustrated, in a quadratic lattice, a honeycomb lattice, a Kagome lattice etc.

According to the prior art technique a line defect is introduced in this lattice structure, for example by omitting a row of elements 6 as illustrated in FIG. 2. Hereby it is achieved that light may propagate through the line defect 8. Light with a frequency within the frequency interval(s) mentioned above may not escape through the lattice structure, and further the light is confined to the slab 4 caused by the total internal reflection by the layers 2 and 3.

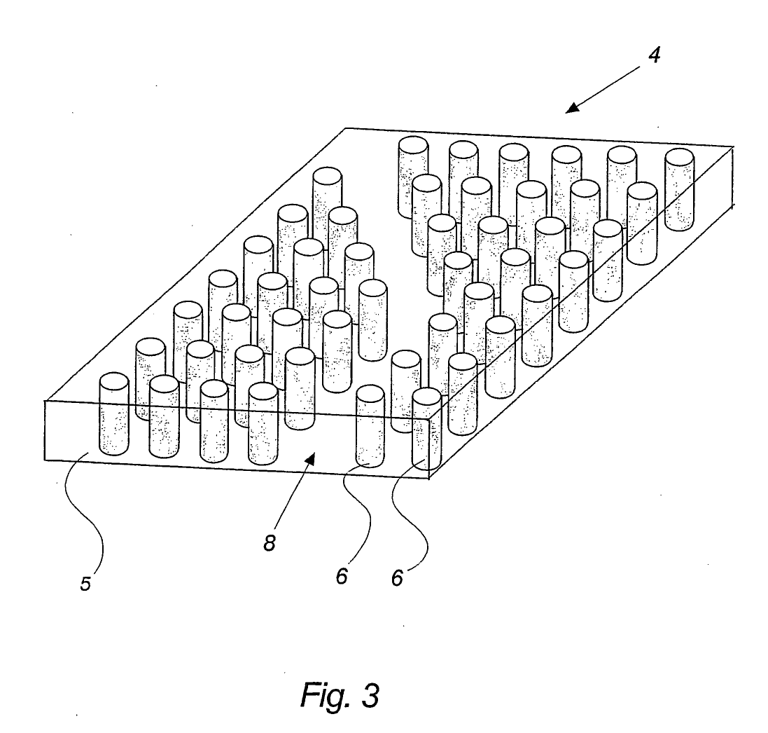

A further example of a prior art technique is illustrated in FIG. 3, which shows a slab 4 corresponding to the above described, e.g. comprising a background material 5 with a number of transversely extending elements or columns 6 arranged in a lattice structure. It will be understood that an upper and a lower layer (not shown in FIG. 3) facilitating total internal reflection will be arranged. A line defect 8 is arranged by omitting a number of elements or columns 6, whereby a region is defined wherein light may propagate. As illustrated this region or line defect 8 may define a waveguide having an angled course, and obviously other forms of courses, e.g. waveguides having curvatures etc. may be arranged in this manner by designing the line defect(s) 8 appropriately.

In the prior art technique the elements or columns 6 have been designed as voids, e.g. cylinders or holes containing air, and have normally been formed by e.g. drilling or etching holes in the slab 4. Further, by the prior art technique a relatively high index ratio i.e. the ratio between the refractive index for the column elements 6 and the refractive index for the background material 5 has normally been desired.

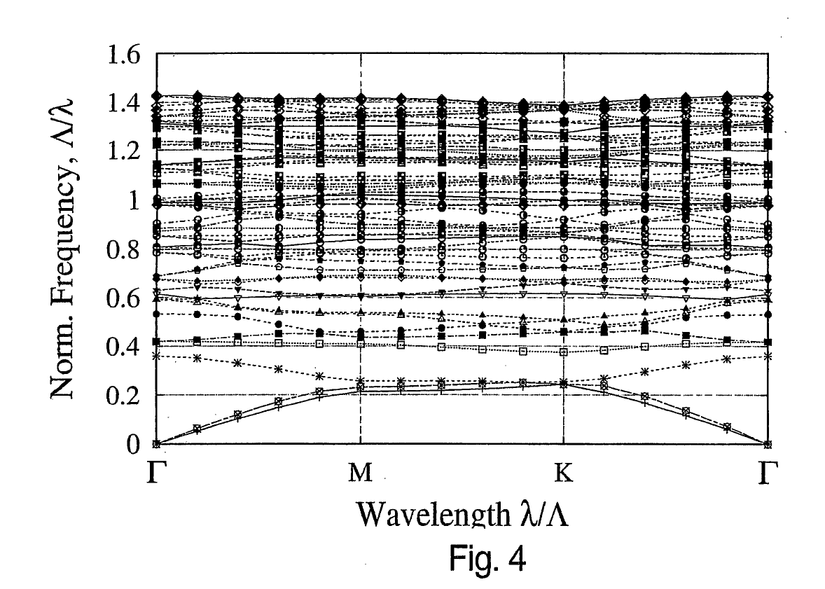

FIG. 4 illustrates a band diagram of a prior art 2D photonic crystal consisting of air holes in a GaAs background material. The air holes have a circular size and a diameter, d, of 0.85Λ, where Λ is the pitch of the 2D photonic crystal. As seen from the figure, the 2D photonic crystal exhibits a complete (i.e. having overlapping Transverse Electric (TE) and Transverse Magnetic (TM) waveguide modes) in-plane bandgap around a normalized frequency, Λ/λ, of 0.39, where λ is the free-space wavelength. For complete reflection of light with a wavelength of 1.55 μm being incident perpendicular to the axis of air holes, the 2D photonic crystal should be designed with Λ of around 0.6 μm and d of around 0.5 μm.

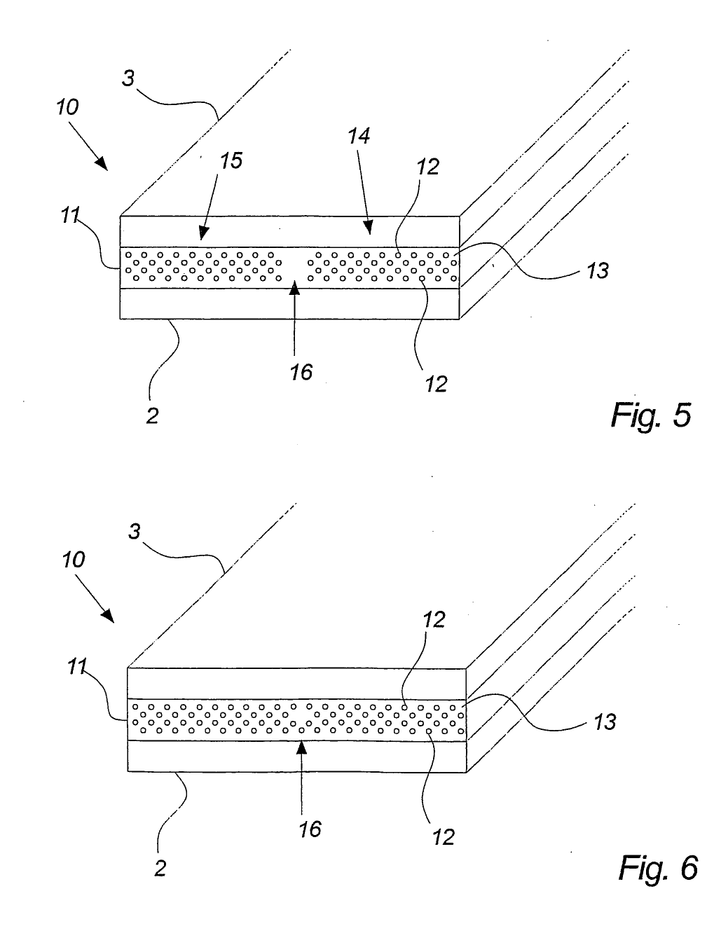

A planar photonic bandgap waveguide generally designated 10 according to an embodiment of the invention is illustrated in FIG. 5. As in the case with the above described prior art, this device comprises a slab 11 with an upper 3 and a lower layer 2 serving to confine light by total internal reflection. The slab 11 comprises a lattice of elements or columns 12, which are elongated and are arranged substantially in an axial direction of the slab 11, e.g. in a direction in the plane defined by the slab 11. These elements or columns 12 may be high index elements, i.e. elements having a higher index of refraction than the background material 13 of the slab 11. It will be understood that these elements or columns 12 will be parallel or substantially parallel and will facilitate a photonic bandgap effect. In order to define a waveguide, e.g. a region within which light may propagate, at least one of the elements 12 of the lattice structure is omitted, whereby a line defect 16 is created.

As indicated in FIG. 5, the line defect 16 may occupy the total height of the slab 11, whereby the lattice structure is divided into two parts 14 and 15. Hereby the photonic bandgap structure will confine light in lateral directions, but not in transverse direction, thus necessitating total internal reflection by the upper and the lower layers 2 and 3.

However, as illustrated in FIG. 6, the line defect 16 may be restricted to only part of the slab in the transverse direction, e.g. only one or a few of the elements 16 may be omitted in the transverse direction, whereby confinement will be achieved also in this direction. The upper and the lower layers 2 and 3 will not need to provide internal reflection and may be omitted or may only serve as a protective cladding or for other purposes.

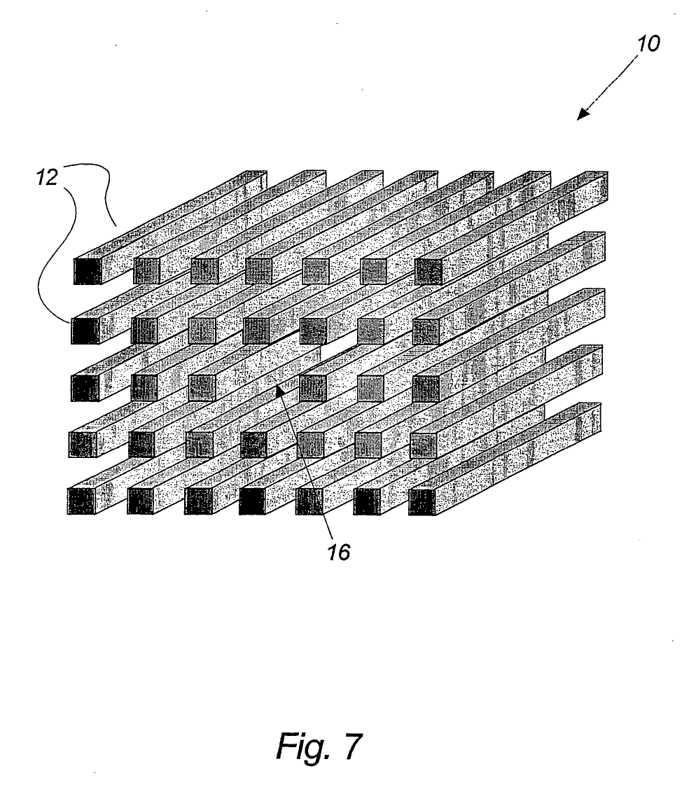

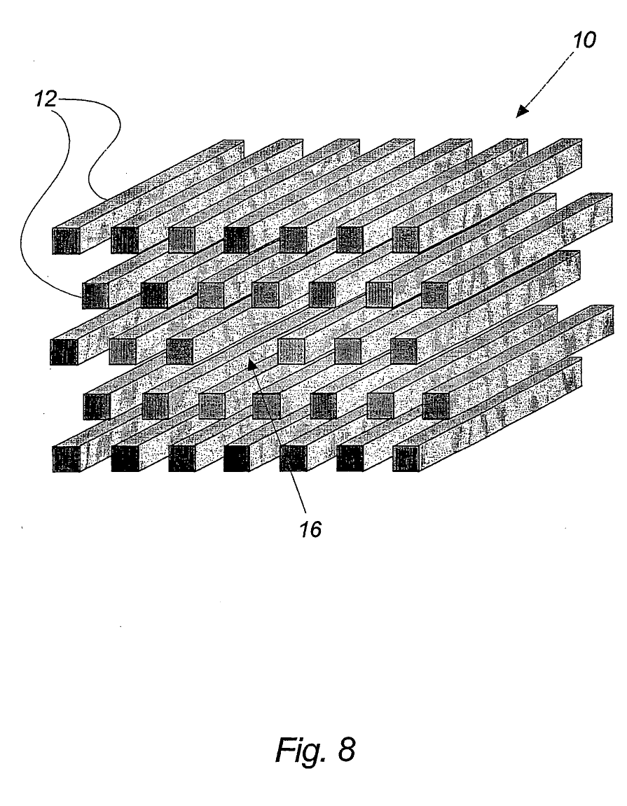

Other embodiments of planar photonic bandgap waveguides according to the invention are illustrated in FIGS. 7 and 8.

These figures illustrate the elongated elements 12 comprised in a waveguide according to the invention, and it will be understood that these elements 12 are surrounded by a suitable background material, e.g. dielectric material.

The elements 12 are arranged in a lattice structure, in FIG. 7 illustrated as a quadratic lattice and in FIG. 8 as a triangular lattice, but it will be understood that other forms of lattices may be used as well, such as honeycomb structures, Kagome structures etc. In both embodiments a single element has been omitted to create the line defect or rather the waveguide region 16 within which light may propagate in the axial direction of the waveguide, confined by the photonic bandgap effect of the lattice structure. It wil be understood that more than one element 12 may be omitted in order to create a line defect and thus define a core region 16 within which light may propagate. Thus the size and the form of the core or waveguide region 16 may vary in accordance with the number and actual selection of element(s) which is/are omitted. Defects may also be formed by placing elements or element groups that are different from the elements 12 forming the cladding.

The elements 12 have been illustrated as elements having a quadratic section but other forms may be used as well, regular forms as well as irregular forms. However, it will be understood that the section of the elements will be substantially uniform along the length of the elements.

According to a further important aspect of the invention the refractive indices of the background material and the material of the elongated elements are selected in order to achieve an index contrast, i.e. the ratio between these indices, having a significantly lower value than ordinarily used in relation to the prior art technique.

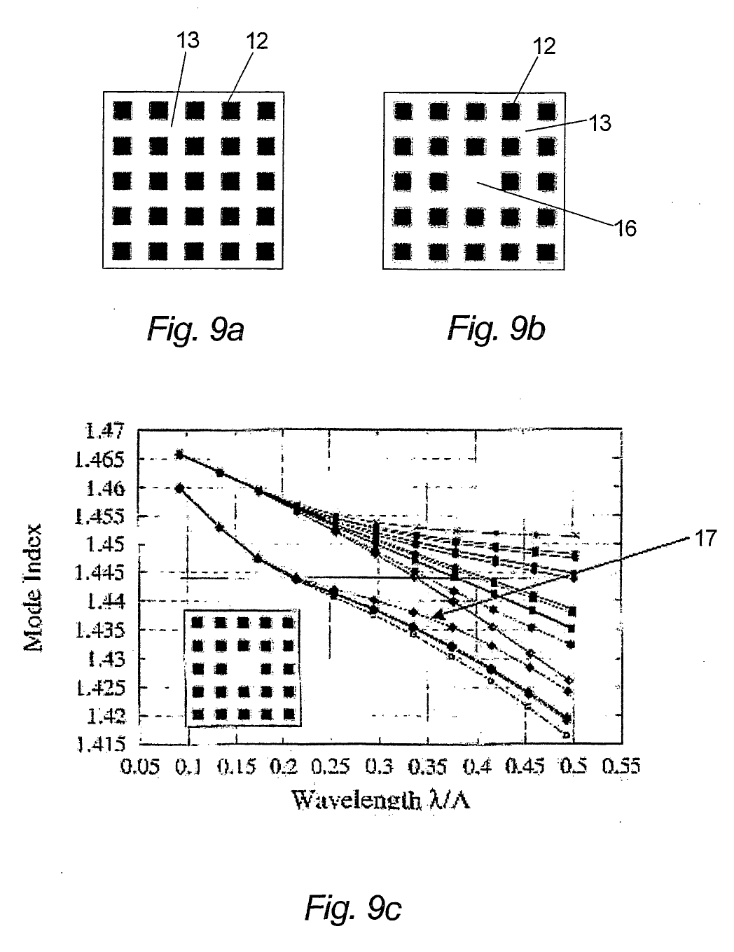

FIG. 9a shows a part of a cross-section of a cladding structure for a planar optical waveguide or planar optical device according to the present invention. The cross-section is characterized by a number of periodically placed features 12 embedded in a background material 13. FIG. 9b shows schematically a part of a cross-section of a planar optical waveguide or a planar optical device according to the present invention. The planar waveguide or device is characterized by a 2D photonic crystal cladding and a central defect 16 formed from a missing feature. In a preferred embodiment, the features have a refractive index difference compared to that of the background material of around 3% or less. Hence, the planar waveguide or device waveguide may be realised using silica technology. It is worth noticing that a single cladding feature 12 may be compared to the core of a conventional planar optical waveguide or device, and the novelty of the present invention is emphasised in that the core of the here-disclosed waveguides are formed by placing a number of ‘conventionel cores’ in a periodic manner and leaving out a single (or more) where the light may be guided. Naturally, other arrangements as well as other shapes of the cladding features may be desired and are also included in the present invention. Furthermore, the core—or defect—may be realised in a number of other manners than illustrated in this figure—such as for example cores comprising one or more features of various sizes, shapes and refractive index profiles.

FIG. 9c shows a calculation of allowed modes in a structure as schematically shown in FIG. 9b. The structure has a background refractive index of 1.444 and the cladding features have a refractive index of 1.47. The figures show a large number of allowed modes in the cladding structure and a single mode 17 that is confined to the core (or defect) of the photonic crystal. As seen for the here chosen design parameters (these being mainly the refractive indices of the background material and of the cladding features as well as their size, arrangement and shape), the core mode is only guided from approximately, Λ/λ of around 0.25 to 0.50. Hence, for operation at a wavelength of around 1.55 μm, Λ should (for this example) be in the range of around 3 μm to 6 μm. The modes are calculated for a non-zero value of propagation constant in the axial direction of the features, i.e. perpendicular to the periodic plane. Hence, the calculated modes will propagate along the features—as desired for the defect mode in a planar waveguide configuration. Similarly, this is desired in for example a laser, where reflection at two separate mirror regions in the longitudinal direction of the planar waveguide or device, may cause light to travel forth and back and build up an intense optical field.

It is worth noticing that the effective index of the guided mode is below 1.444, i.e. lower than the refractive index of the background material or any other material that the photonic crystal is composed of. This is a unique feature compared to conventional planar optical waveguides, where the effective refractive index of one or more guided modes are between the refractive indices of the cladding and the core material. Hence, the present invention relieves some of the restrictions on core refractive index that characterizes conventional planar optical waveguides. In this manner, it becomes for example possible with the present invention to utilize new materials for the core—for example having the core formed from a liquid or a polymer, or the core may simply be formed in pure silica for a low loss planar optical waveguide, where most or all material processing during fabrication is performed away from the core center. Other possibilities include having a silica core doped with new materials that lower the refractive index of silica—such as materials that are not being employed or have not been studied for conventional planar optical waveguides due to their effect of lowering the refractive index. Also other co-dopants, such as for example F that may presently only be used in small concentration in the core of a conventional planar optical waveguide or device (such as a laser or amplifier) could be used in larger concentrations in a planar optical waveguide or device according to the present invention. This may for example be beneficial for increased solubility of one or more rare earth elements such as for example Er and/or Yb into the core.

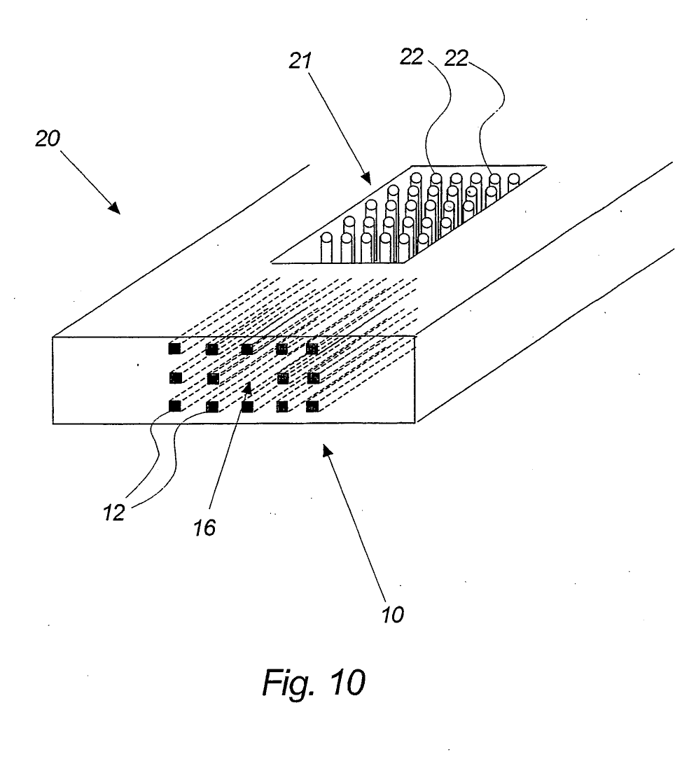

FIG. 10 illustrates a planar optical waveguide according to the invention generally designated 10, e.g. comprising elongated elements 12 in a lattice structure and having a line defect 16, which has been combined with a prior art planar photonic bandgap device 21, e.g. comprising transversely extending column elements 22, forming a hybrid optical device. Hereby an optical device may be designed involving new combination of advantageous features.

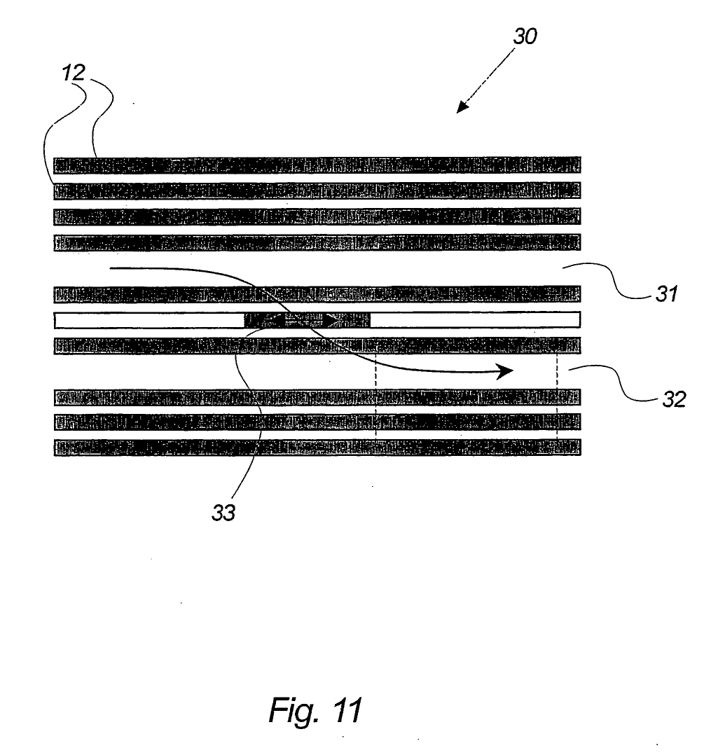

FIG. 11 illustrates an optical device generally designated 30 according to a further embodiment of the invention, comprising a planar optical waveguide structure according to the invention. A number of elongated elements 12 are arranged in a lattice structure, and two or more of these elements 12 are omitted, whereby two (or more) waveguides 31 and 32 are defined. These may be arranged in parallel or substantially parallel as illustrated. Between these waveguides 31 and 32 a coupling element 33 is arranged, by means of which light propagating along one of the waveguides, e.g. 31 may be transferred to the other waveguide 32 (or to one or more other waveguides). The coupling element 33, which serves to “interrupt” the lattice structure of the photonic bandgap structure, whereby light may propagate via the coupling element 33, is preferably movable as illustrated whereby the coupling point may be controllably moved. Means to move the coupling element 33 may e.g. be through heating of closed gas chambers (and thereby change of volume/pressure) at one (or both) sides of a liquid filled section—the coupling element. Alternative approaches may be the application of a material sensitive to localized influences such as temperature change, electromagnetic fields, pressure etc. at a specific location along the waveguides.

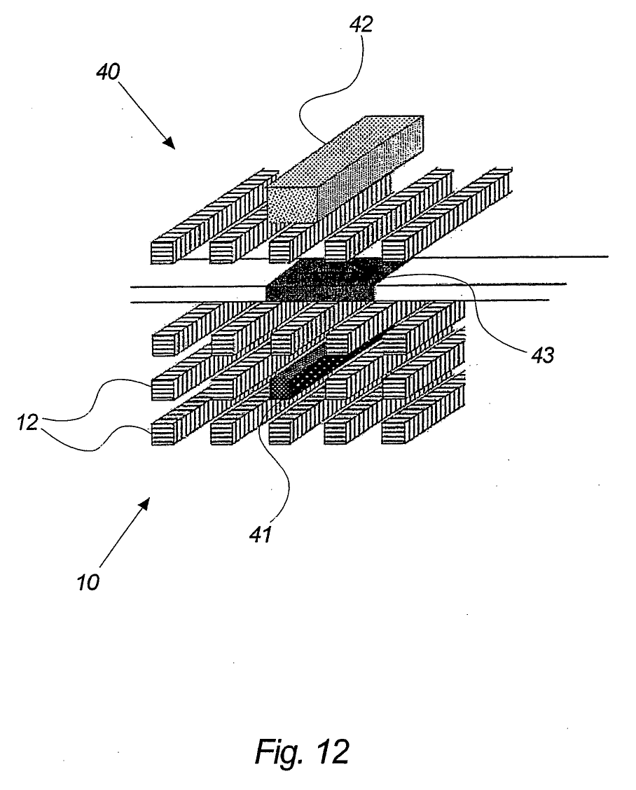

FIG. 12 illustrates a further optical device generally designated 40 according to an embodiment of the invention, comprising a planar optical waveguide structure 10 according to the invention. The planar optical waveguide structure 10 comprises a number of elongated elements 12 arranged in a background material. One 41 (or more) of the elements comprises a material having a refractive index different from the other elements whereby a waveguide is provided in the PBG structure 10. Further, another waveguide 42 is arranged in, near or at this optical device. This waveguide 42 may be a conventional waveguide, e.g. an optical fibre. Further, the optical device comprises a coupling element 43, which is movable as illustrated, e.g. connected by a rod, string or the like to movable means. Alternative means for obtaining the coupling element 43 may include the application of micro-flow systems containing different elements of liquids that do not mix and which have different refractive indices and, therefore, result in modified coupling properties as the coupling element 43 is moved. For example could an oil filling surrounded by water sections provide a movable section through the use of micro-flow methods shifting the location of the oil section. In a certain position or positions the coupling element may serve to provide guidance of light from or to the waveguide 42 to or from the waveguide element 41, whereby the optical device 40 may serve as an optical switch. The coupling element 43 may be connected to means, which are movable in response to certain specific circumstances, e.g. temperature, pressure, strain, flow, electric current, voltage, etc. whereby the optical device may serve as a transducer.

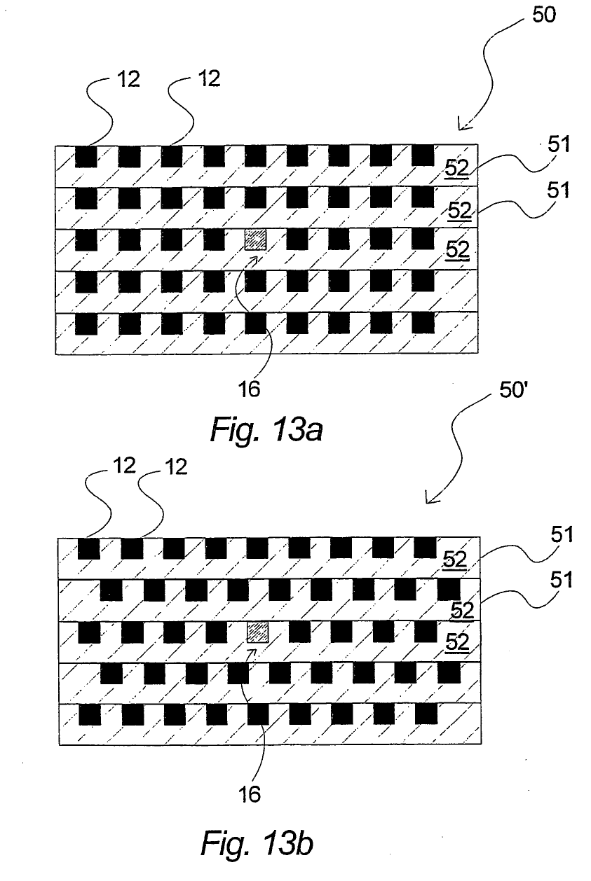

FIG. 13 illustrates a planar optical waveguide according to the invention and in particular a layered construction of such a device. FIG. 13a illustrates a device 50 having a quadratic lattice structure while FIG. 13b illustrates a device 50′ with a triangular lattice structure. Both comprise a number of layers 51, each of these layers comprising a planar or essentially planar slab 52, in which a number of elongated elements 12, e.g. elements having a refractive index different from the material of the slab 52, may be arranged. The waveguide region 16 may be provided by omitting one or more of the elements 12 in one or more of the layers 51, essentially as explained above, or by arranging one or more element having a suitable refractive index instead of the elements 12. It will be understood that the planar optical waveguides according to the invention may be manufactured by stacking such layers on top of each other.

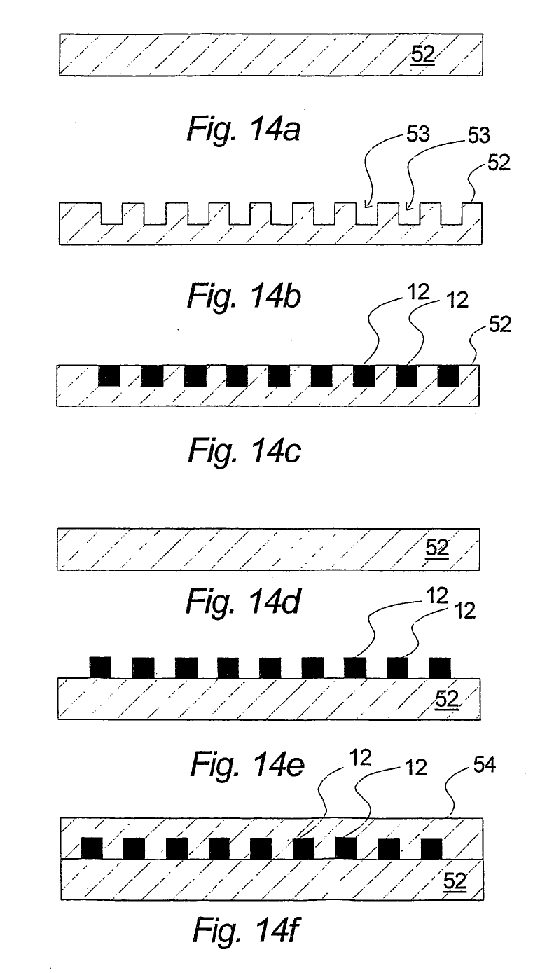

The individual layers 51 may be manufactured in a number of ways which will be illustrated with reference to FIG. 14. FIG. 14a shows a slab or layer 52, which may form the basis of a planar optical waveguide. In FIG. 14b it is illustrated that a number of elongated recesses 53 have been made in the layer 52. Such recesses may be made e.g. by etching, machining etc. using templates or the like or without using such templates. These methods are generally available, which will be evident to a skilled person. In FIG. 14c it is illustrated that these recesses 52 may be filled with a material having a refractive index differing from the refractive index of the slab material, i.e. in order to create the lattice structure of elements 12 according to the invention. These elements 12 may be placed in the recesses 53 in a number of ways, e.g. by molding etc. It will be understood that the next step in the process may be to place a further layer 52 on top of the layer shown in FIG. 14c and then proceed as previously described. The layers may be connected to each other by means of molding, curing etc.

FIG. 14d to 14f illustrates another method of manufacturing layers for a device according to the invention. FIG. 14d illustrates the basis of the process in the form of a layer 52, corresponding to FIG. 14a. On top of this layer elongated members 12 are placed in parallel and in predefined locations in order to create the lattice structure. These members may be placed by molding, depositing etc. The next step illustrated in FIG. 14f incorporates the introduction of the next layer of background material 54, which may be deposited, molded etc.

It will be understood that such layered construction may be made in a number of ways, e.g. using depositing, etching and/or lithographic processes.

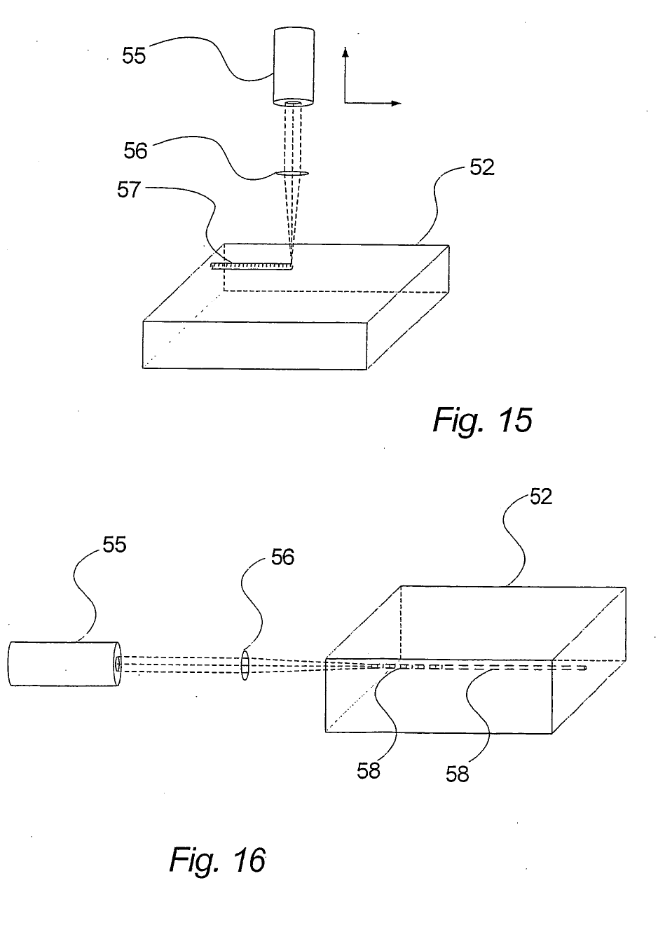

FIG. 15 illustrates a further method of manufacturing an optical device according to the invention. This method utilizes laser induced refractive index changes, whereby the necessary elongated elements 12 having differing refractive indices may be made in or on a slab or a layer of dielectric. Such a layer or slab 52 is shown in FIG. 15, and a laser arrangement, e.g. comprising a UV-laser 55 and possibly optical lenses etc. 56, is shown. The laser beam may change the refractive index of the slab material when appropriately controlled, and by moving the laser arrangement and the slab 52 in relation to each other, the elongated elements 57 may be formed.

FIG. 16 illustrates a still further method also using a laser arrangement 55, 56 for manufacturing a lattice structure according to the invention. This arrangement utilizes the self writing effect, whereby waveguides may be self-written. By subjecting a material to a laser beam, e.g. a UV laser beam, the material will change its refractive index, and a channel (micro-channel) 58 will be created. The laser beam will propagate through this channel 58, and eventually an elongated element having a changed refractive index, i.e. a self-written element, will be created in a linear manner as illustrated by the indication 58 in the slab 52.

Other methods may be used as well, e.g. comprising steps involving ion implantation etc.

The invention has been described above in general, but it will be understood that the waveguide according to the invention may be used in connection with a wide variety of applications.

It will also be understood that the invention is not limited to the particular examples described above, but may be designed in a multitude of varieties within the scope of the invention as specified in the claims.

1. Planar optical waveguide comprising
a core region and
a cladding region comprising a photonic crystal material,
said photonic crystal material having a lattice of column elements, wherein at least a number of said column elements are elongated substantially in an axial direction for said core region.

2. Planar optical waveguide according to claim 1, wherein said core region at least partly is in the form of a defect in said lattice of the photonic crystal material.

3. Planar optical waveguide according to claim 1, wherein said core region comprises a material having a low effective index of refraction and said cladding region involves a higher effective index of refraction.

4. Planar optical waveguide according to claim 3, wherein said cladding region comprises a background material having a first refractive index, said column of elements comprise a material having a second refractive index, and said second refractive index is higher than said first refractive index.

5. Planar optical waveguide according to claim 3, wherein said cladding region comprises a background material having a first refractive index, said column of elements comprise a material having a second refractive index, and said second refractive index is lower than said first refractive index.

6. Planar optical waveguide according to claim 4, wherein a ratio between said second refractive index for said column element(s) and said first refractive index for said background material, is defined and said ratio is less than about 2.0.

7. Planar optical waveguide according to claim 6, wherein said effective refractive ratio for said cladding region is less than about 1.5.

8. Planar optical waveguide according to claim 6, wherein said effective refractive ratio for said cladding region is less than about 1.05.

9. Planar optical waveguide according to claim 1, wherein said core region comprises a material identical to or similar to a material forming background material of said cladding region.

10. Planar optical waveguide according to claim 1, wherein said columns elements comprises a material containing impurity elements.

11. Planar optical waveguide according to claim 1, wherein said waveguide comprises at least one of a glass materials, a semiconductor materials, and a polymer materials.

12. Planar optical waveguide according to claim 1, wherein said cladding region comprises a background material comprising SiO2 and said background material has a first refractive index (n1), wherein 1.4≦n1≦1.5.

13. Planar optical waveguide according to claim 1, wherein said cladding region comprises a background material comprising Si and having a first refractive index (n1), wherein 2.5≦n1≦3.0.

14. Planar optical waveguide according to claim 1, wherein said cladding region comprises a background material comprising a Group III-V material and having a first refractive index (n1), wherein 3.0≦n1≦4.5.

15. Planar optical waveguide according to claim 1, wherein said column elements comprise a material comprising of SiO2 and having a second refractive index (n2), wherein 1.0≦n2≦1.5.

16. Planar optical waveguide according to claim 1, wherein said column elements comprise a material comprising Si and having a second refractive index (n2), wherein 1.0≦n2≦3.0.

17. Planar optical waveguide according to claim 1, wherein said column elements comprise a material comprising of a Group III-V material and having a second refractive index (n2), wherein 1.0≦n2≦4.5.

18. Planar optical waveguide according to claim 1, wherein said lattice of column elements comprises a lattice constant (L), a normalized wavelength l/L is defined by means of said lattice constant (L) and a wavelength (l) for optical waves propagated by the waveguide, and said cladding region comprises a background material comprising SiO2, wherein L/l<1.0.

19. Planar optical waveguide according to claim 1, wherein said lattice of column elements comprises a lattice constant (L), a normalized wavelength l/L is defined by means of said lattice constant (L) and a wavelength (l) for optical waves propagated by the waveguide, and said cladding region comprises a background material comprising Si wherein L/l<2.0.

20. Planar optical waveguide according to claim 1, wherein said lattice of column elements comprises a lattice constant (L), a normalized wavelength l/L is defined by means of said lattice constant (L) and a wavelength (l) for optical waves propagated by the waveguide, and said cladding region comprises a background material comprising Group III-V material, wherein L/l<3.0.

21. Planar optical waveguide according to claim 1, wherein said cladding region comprises a background material having a first refractive index, and wherein an effective guided mode index is lower than said first refractive index.

22. Planar optical waveguide according to claim 1, wherein said column elements comprise a material having a second refractive index, and wherein an effective guided mode index is lower than said second refractive index.

23. Optical device comprising a planar optical waveguide according to claim 1.

24. Optical device comprising an optical amplifier further comprising a planar optical waveguide according to claim 1.

25. Optical device comprising a laser further comprising a planar optical waveguide according to claim 1.

26. Optical device comprising an optical filter further comprising a planar optical waveguide according to claim 1.

27. Optical device comprising an add-drop multiplexer further comprising a planar optical waveguide according to claim 1.

28. Optical device comprising an optical splitter further comprising a planar optical waveguide according to claim 1.

29. Optical device comprising a wavelength converter further comprising a planar optical waveguide according to claim 1.

30. Optical device comprising means for performing an optical switching, a controllable coupling, or a transferal of optical waves, said optical device further comprising a planar optical device according to claim 1.

31. Optical device according to claim 30, wherein said means for performing an optical switching, a controllable coupling, or a transferal of optical waves comprise a movable coupling element.

32. Optical device according to claim 31, wherein the device comprises means for actuating said movable coupling element.

33. Optical device according to claim 32, wherein said means for actuating said movable coupling element involve the use of mechanical means, means sensitive to heating and/or cooling, means sensitive to pressure, and/or means sensitive to electromagnetic fields.

34. Optical device according to claim 30, wherein said device comprises micro-flow means associated with said optical switching, controllable coupling, or transferal of optical waves.

35. Optical device according to claim 34, wherein said micro-flow means involves utilization of a fluid, comprising two or more fluid elements having different refractive indices.

36. Optical device according to claim 35, wherein said two or more fluid elements comprised in said micro-flow system are separated by mechanical means or said two or more fluid elements are non-mixable fluid elements or essentially non-mixable fluid elements

37. Method of making a planar optical waveguide according to claim 1, comprising multi-layer depositing and/or processing.

38. Method according to claim 37, further comprising depositing, etching and/or lithographic processes.

39. Method of making a planar optical waveguide according to claim 1, comprising laser induced refractive index changes.

40. Method of making a planar optical waveguide according to claim 1, comprising utilizing self-writing waveguides.

41. Method of making a planar optical waveguide according to claim 1, comprising ion implantation.

42. Planar optical waveguide according to claim 5, wherein a ratio between said second refractive index for said column element(s) and said first refractive index for said background material, is defined and said ratio is less than 2.0.

43. Planar optical waveguide according to claim 42, wherein said effective refractive ratio for said cladding region is less than about 1.5.

44. Planar optical waveguide according to claim 42, wherein said effective refractive ratio for said cladding region is less than about 1.05.
